(19) United States
(12) Patent Application Publication
(10) Pub. No.: US 2009/0031765 A1
(43) Pub. Date: Feb. 5, 2009

(54) Multi-function steering wheel lock

(76) Inventor: Kou-Tsin Liu, Taipei (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 11/878,974

(22) Filed: Jul. 30, 2007

(51) Int. Cl. B60R 25/02

(52) U.S. Cl. 70/209

(57) ABSTRACT

A multi-function steering wheel lock includes a stub axle tube (1) has an axial hole (15), a lock head (11) and a buckle (12) at a first end, a stub end (18) at a second end. A kingpin axle (2) has a buckle (21) at a first end can slide in the axial hole (15), thereby the lock head (11) sets limit to a range of movement of the kingpin axle (2). A two pole convergence yoke tube (3), on one hand, inserts into the stub end (18); on the other hand, slides vertically relate to the stub axle tube (1) to free the kingpin axle (2). A holding console (5) is pivotally connected to the yoke tube (3). As a result, a steering wheel and an audio system can be fixed by the yoke tube (3) and the holding console (5).

### FIELD OF THE INVENTION

The present invention is related to a multi-function steering wheel lock, in particular, to a lock can be operated for anti-theft protection, includes air bag, audio system, and steering wheel are locked or shielded.

### BACKGROUND OF THE INVENTION

Generally speaking, conventional steering wheel locks are classified into two categories. As shown in FIG. 1A, one conventional steering wheel lock includes a stub axle tube (91) has a lock head (93) and a buckle (92) (i.e. shield) at a first end; a kingpin axle (94) has a buckle (95) (i.e. lock fork) at a first end can slide in the stub axle tube (91) to interlock with the lock head (93). The buckle (92) (i.e. shield) has wave-like notches (921) at a first end (i.e. open end) in coordination with the buckle (95) (i.e. lock fork) to clamp the three spoke steering wheel altogether.

As shown in FIG. 1B, the other conventional auto steering wheel lock includes a stub axle tube (91) has a lock head (93) and a buckle (96) (i.e. lock fork) at a first end, and a kingpin axle (94) has a buckle (97) at a first end can slide in the stub axle tube (91) to interlock with the lock head (93). These two buckles (96, 97) (i.e. two lock forks) are able to clamp a steering wheel to prevent car from being operated by an unauthorized person.

The conventional steering wheel lock can be known as depicted in FIGS. 1A and 1B still has some defects. For example, although two buckles (95,92) (i.e. lock fork, shield) and two buckles (96,97) (i.e. two lock forks) are used to clamp a three-spoke steering wheel, but an audio system, even an airbag at the center of the steering wheel are not under anti-theft protection. Under such circumstance, the steering wheel is the only item protected by the shield or lock fork, other items such as airbag or audio system are not under consideration of so called “steering wheel lock” anti-theft protection.

Persons skilled in the art have provided a steering wheel lock to protect car as well as audio system such as TW133168 entitled “Steering wheel and audio system anti-theft lock” to King-Yuan Wang on Apr. 21, 1990, Wang taught a kingpin axle (2) has a fork lock (8A) welded to a first end, and the kingpin axle (2) slides through a stub axle tube (1) to interlock with the same locked by a first lock head (6). A second end of the stub axle tube (1) has a lock fork (8B) welded thereto; a second end of the kingpin axle (2) has a “stub end” (3), which is pivotally connected to a base (4), which can therefore be swung to and fro relative to the base (4). The base also has a hole (41) accommodates the lock fork (8B) inserted therein. A screw (42) inside the hole (4) can adjust a depth of the hole (41) for receiving the fork lock (8B) properly. The base (4) accommodates a rod (9) passed through interlocking with a second lock head (6), a distal end of the rod is connected to a plate (5) which is able to cover audio system.

The defect of TW 133168 can be known as the lock heads (6) must be equipped with a first lock head (6) and a second lock head (6). The first lock head (6) secures the kingpin axle (2) to the stub axle tube (1); the second lock head (6) secures the rod (9) to the base (4). Whenever this conventional steering wheel lock is open/close, both a stub axle tube (1) and a rod (9) should be operated in two directions, once one of them is not responded to the open/close action, the steering wheel may be locked or unlocked in different parts for a while, that is not expected by users.

Secondly, TW 133168 stated that it can also fasten a steering wheel and audio system, but it can not protect the airbag at the center of steering wheel.

### SUMMARY OF THE INVENTION

Accordingly, the present invention is to provide a multi-function steering wheel lock to prevent steering wheel, audio system and air bag from being stolen by non-authorized person.

Point against aforesaid problems, the present invention is to provide a multi-function steering wheel lock comprising: a stub axle tube (1) has an axial hole (15), a lock head (11) and a buckle (12) at a first end, a stub end (18) at a second end; a kingpin axle (2) slides in the axial hole (15) of the stub axle tube (1) also has a buckle (21) at a first end, thereby the lock head (11) sets a limit to a range of movement of the kingpin axle (2); wherein a two pole convergence yoke tubes (3), on one hand, inserts into the stub end (18), on the other hand, vertically connected to the stub axle tube (1) is in coordination with the kingpin axle (2), which is restricted to the fastening status—to be locked or not—is determined by a yoke tube (3) making a sliding movement perpendicular to the stub axle tube (1); in addition, a holding console (5) is pivotally connected to a first end of the yoke tube (3).

Point against aforesaid problems, the present invention is to provide a multi-function steering wheel lock as mentioned above comprising a stub axle tube (1) has a lock head (11), a buckle (12), and an axial hole (15) at a first end; a guiding pole (13) at a second end coupled to the stub axle tube (1) vertically; a kingpin axle (2) slides in an axial hole (15) of the stub axle tube (1) has a buckle (21) at a first end, where the lock head (11) sets a limit to the kingpin axle (2); and a yoke tube (3) is pivotally connected to the guiding pole (13), a first end of the yoke tube (3) led to a lower portion of the guiding pole (13); thereby, whether the yoke tube (3) is in a locked status or released from the locked status is determined by the kingpin axle (2); a second end of the yoke tube (3) has a holding console (5).

### BRIEF DESCRIPTION OF THE DRAWINGS

FIG. 1A: is a perspective view of a conventional steering wheel lock.

FIG. 1B: is a perspective view of another conventional steering wheel lock.

FIG. 2: is an exploded view of the first embodiment of the invention.

FIG. 3: is an assembly view of FIG. 2.

FIGS. 4, 4A, 5, 5A: are diagrammatic views of a fastener in a stub end, where

FIGS. 4A and 5A are enlarged views indicated in FIGS. 4 and 5 respectively.

FIG. 6: is a perspective view with a partly enlarged view of another embodiment of a fastener in a stub end.

FIGS. 7˜8: are diagrammatic views of another embodiment of a handle of FIG. 2 in practice.

FIG. 9: is a diagrammatic view of a yoke tube coupled with a holding console of FIG. 2.

FIG. 10: is a diagrammatic view of FIG. 2 in practice.

FIG. 11: is a diagrammatic view of rotating a holding console.

FIG. 12A˜12C: are diagrammatic views of a bolt of FIG. 9 fit between a holding console and a yoke tube at different locations.

FIG. 13: is a diagrammatic view of another embodiment of a yoke tube of FIG. 9.

FIG. 14: is a diagrammatic view of rotating a holding console of FIG. 13.

FIG. 15: is an exploded view of a first type of the second embodiment of the invention.

FIG. 16: is a perspective view of rest of buckles of FIG. 15 in practice.

FIG. 17: is a perspective view of a first type of the second embodiment of the invention, the steering wheel is released from a “locked” status.

FIG. 18: is a perspective view of a locked steering wheel of FIG. 17.

FIG. 19: is a perspective view of a locked steering wheel of the second type of second embodiment of the invention.

FIG. 20: is an exploded view of the steering wheel of a third type of the second embodiment of the invention.

FIG. 21: is an exploded view of the steering wheel of a fourth type of the second embodiment of the invention.

FIG. 22: is a perspective view of a locked steering wheel of FIG. 21.

FIG. 23: is a diagrammatic view of the yoke tube coupled with the holding console of the second embodiment of the invention.

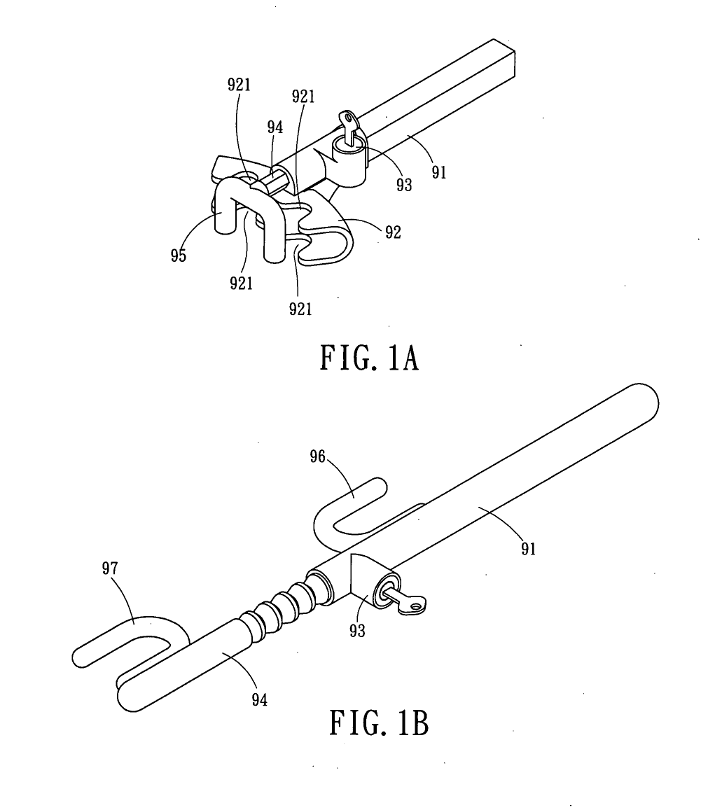

### DETAILED DESCRIPTION OF THE PREFERRED EMBODIMENTS OF THE INVENTION

The description is described in detail according to the appended drawings hereinafter.

### First Embodiment

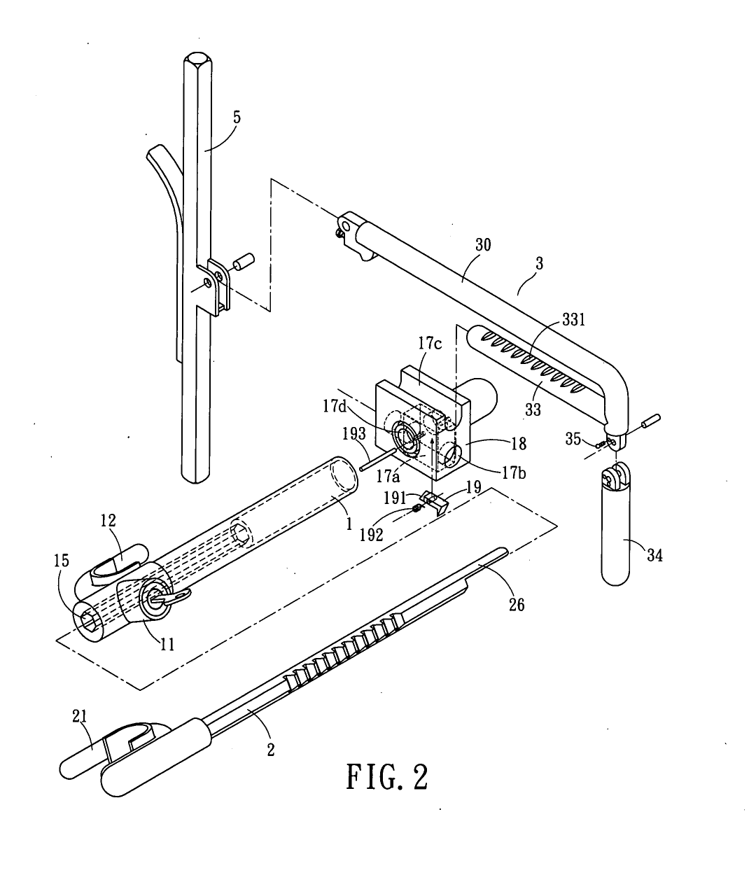

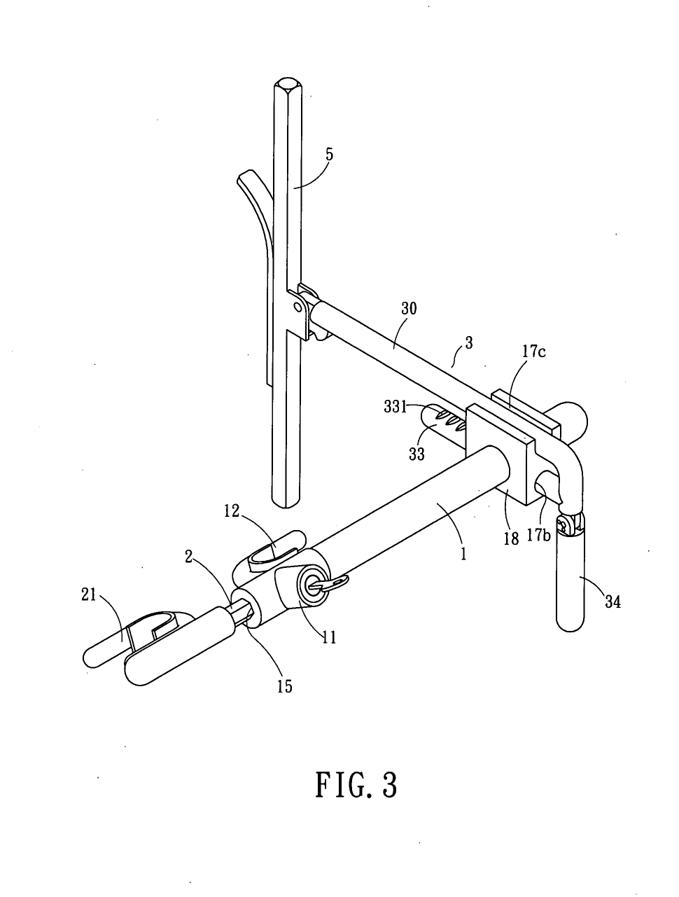

As shown in FIGS. 2˜5, a steering wheel lock includes a stub axle tube (1) has an axial hole (15) formed at a first end, where a lock head (11) and a buckle (12) are incorporated to the stub axle tube (1) near the first end. A kingpin axle (2) can lead in or lead out the axial hole (15) by a second end, while a buckle (21) is also attached to a first end of the kingpin axle (2). The kingpin axle (2) slides in the axial hole (15) to be locked or not is determined by the lock head (11). That is, when the kingpin axle (2) slides in the axial hole (15) in only one direction, a series of clicks sounds may be heard, till a key inserted in the lock head (11) is switched, the kingpin axle (2) is fixed to the axial hole (15).

Whether the kingpin axle (2) is restricted movement in position—to be locked or not—is determined by a yoke tube (3) making a sliding movement perpendicular to the stub axle tube (1), where the yoke tube (3) has a stub axle (33) inserted into a stub end (18). In addition, a holding console (5) is pivotally connected to a first end of the yoke tube (3). A fastener (19) disposed inside the stub end (18) can set a limit to a range of movement of the yoke tube (2), the fastener (19) is impelled by a positioning bolt (26) extended from a second end of the kingpin axle (2) to release the kingpin axle (2) from the fastening status.

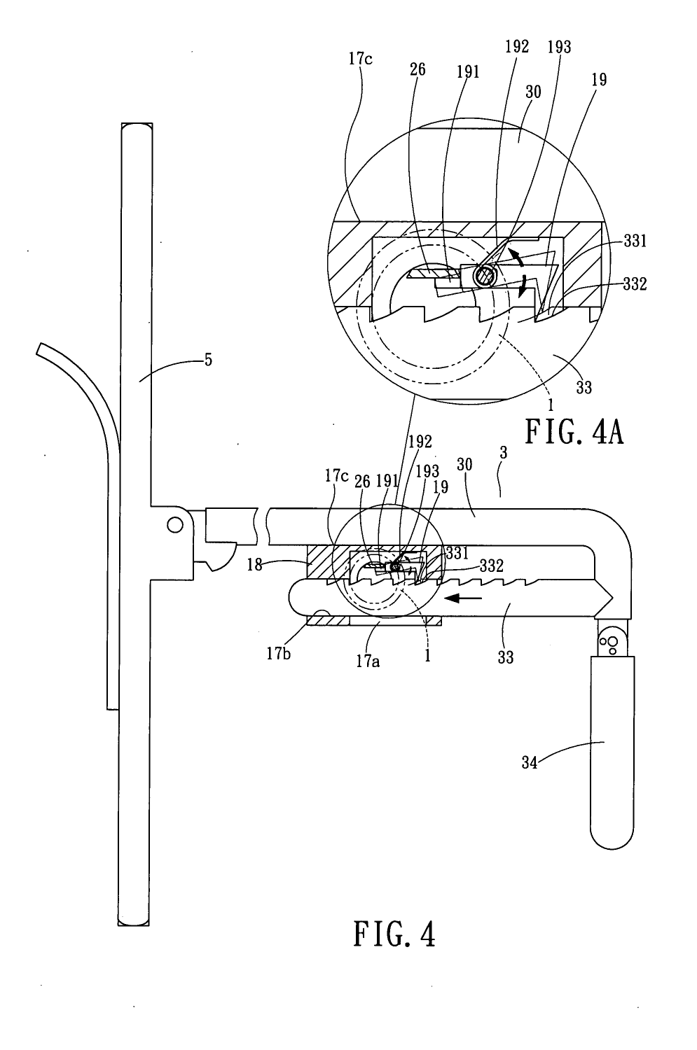

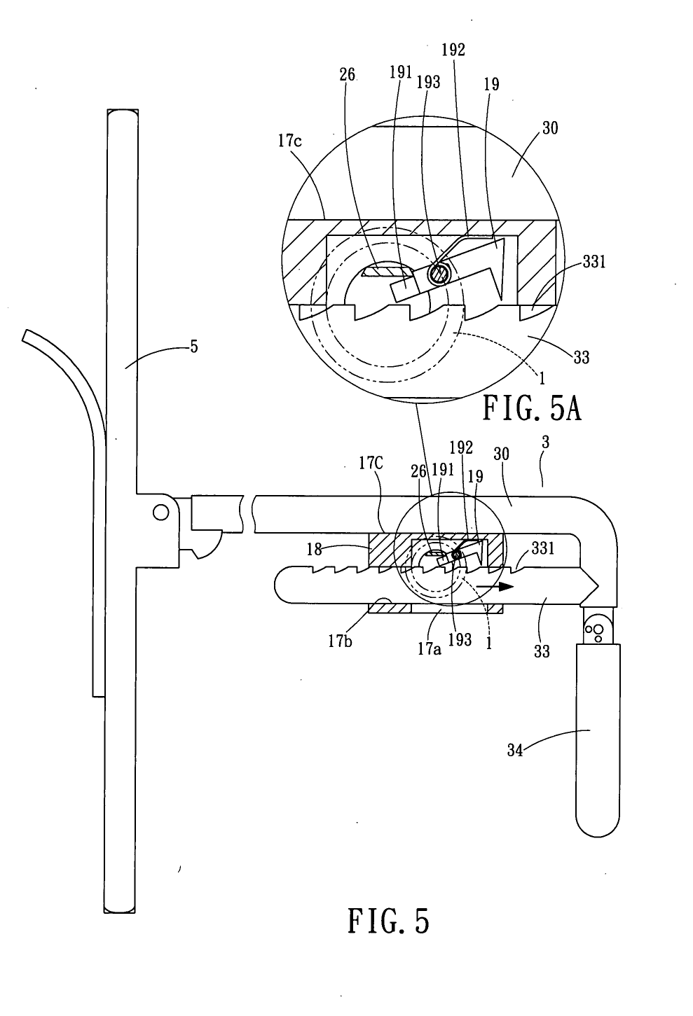

As mentioned above, the yoke tube (3) includes a branched pole (30) is mainly parallel to the stub axle (33), but a second end of the branched pole (30) is connected to a second end of the stub axle (33) and then extended toward a handle (34), which can be separated from the yoke tube (3) or folded in toward the yoke tube (3). Where the handle (34) is connected to the yoke tube (3) by an elastic positioning member (35), which is composed of a ball urged by a spring loaded within a tube, which is inserted through a 8-shaped hole formed between the handle (34) and the yoke tube (3). The stub axle (33) has a plurality of toothed notches (331) formed on one surface, each of which is a one-sided beveled notch conformed to the fastener (19) to limit the range of movement of the kingpin axle (2) sliding through the stub axle tube (1) in only one direction. Inside the stub end (18), there has a passage portion (17a) accommodates the fastener (19) pivotally mounted therein. An axial hole (17b) formed through the passage portion (17a) accommodates the inserted stub axle (33) sliding through the axial hole (17b). A guiding groove (17c) is paralleling to the axial hole (17b) accommodates the branched pole (30) sliding along the half-opened guiding groove (17c). And a guiding hole (17d) is formed through the passage portion (17a) and the axial hole (15). The fastener (19) is L-shaped with a slope surface (191) at a first end. The fastener (19) is in response to a spring (192) pivotally mounted inside the passage portion (17a), and the spring (192) is fixed in the passage portion by a bolt (193) transversally inserted through the spring (192). Furthermore, the positioning bolt (26) shaped as a tongue-like tip is in contact with the slope surface (191), which is therefore to leverage a second end of the L-shaped fastener (19) tapers to a thin edge upward in counterclockwise direction. Thereby, the fastener (19) is released from a locked status, which is the thin edge of L-shaped fastener (19) interlocked with the one-sided beveled notches, to facilitate the next mating between the stub axle (33) and the fastener (19). Those continuous actions are illustrated by two enlarged views of FIGS. 4A and 5A. As a result, the yoke tube (3) can slide in one direction; meanwhile, the holding console (5) shields an audio system in position, and the kingpin axle (2) is locked to the stub axle tube (1) by the lock head (11) as well. Buckles or U-shaped lock forks (12, 21) of this embodiment are corresponding to each other facing in a reverse direction, but not opposite to each other. Thereby, they can clamp three-spoke steering wheel from inner sides.

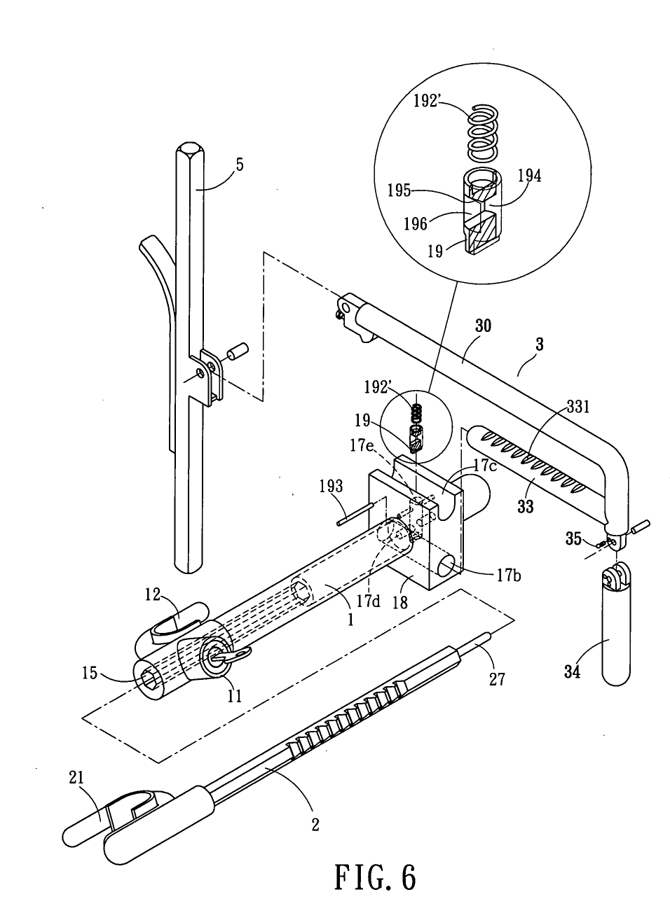

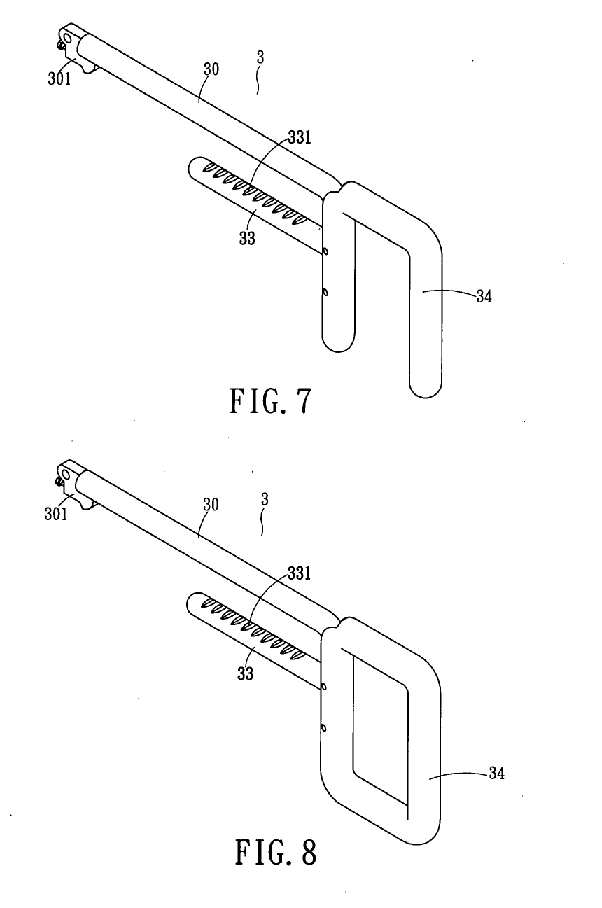

As shown in FIG. 6, another embodiment of the fastener (19) coupled to the stub end (18) is illustrated. Inside the stub end (18), the axial hole (17b) is provided for receiving and sliding the stub axle (33) therein. A guiding groove (17c) is parallel to the axial hole (17b) allows the branched pole (30) sliding along, a bore (17e) is in radial communication with the axial hole (17b) for receiving the fastener (19) mounted therein, a guiding hole (17d) is formed through the axial hole (17b) and the axial hole (15) of the stub axle tube (1). The fastener (19) is shaped as a tube, which has a spring (192′) loaded within a bore (194). A bolt (193) transversally inserts through the bore (194) to fix the spring (192′) to the bore (194). A proximal end of the bore (194) is an opening (196) with a slope surface (195). A positioning bolt (27) extended from a second end of the kingpin axle (2) impels the slope surface (195), by which the fastener (19) is elastically displaced upward. As a result, the yoke tube (3) slides in one direction to move the holding console (5) shields the audio system in position. In other words, the positioning bolt (27) impels the fastener (19) to release the kingpin axle (2) from being fixed to the stub axle tube (1); the kingpin axle (2) is further leded out and separated from the stub axle tube (1). In addition, a handle (34) of the yoke tube can be shaped as a U-shaped handle (as shown in FIG. 7), or a rectangle shaped handle. (as shown in FIG. 8)

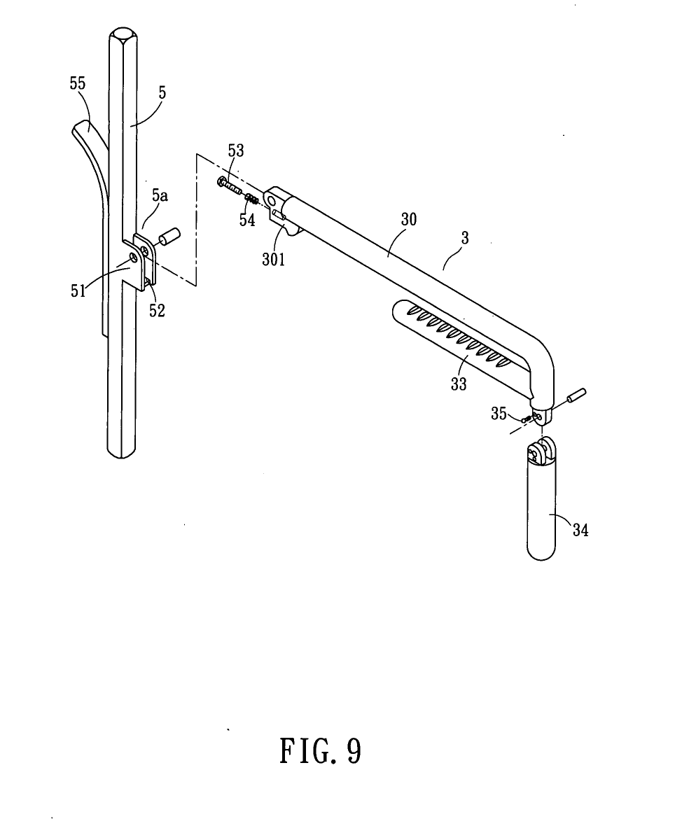

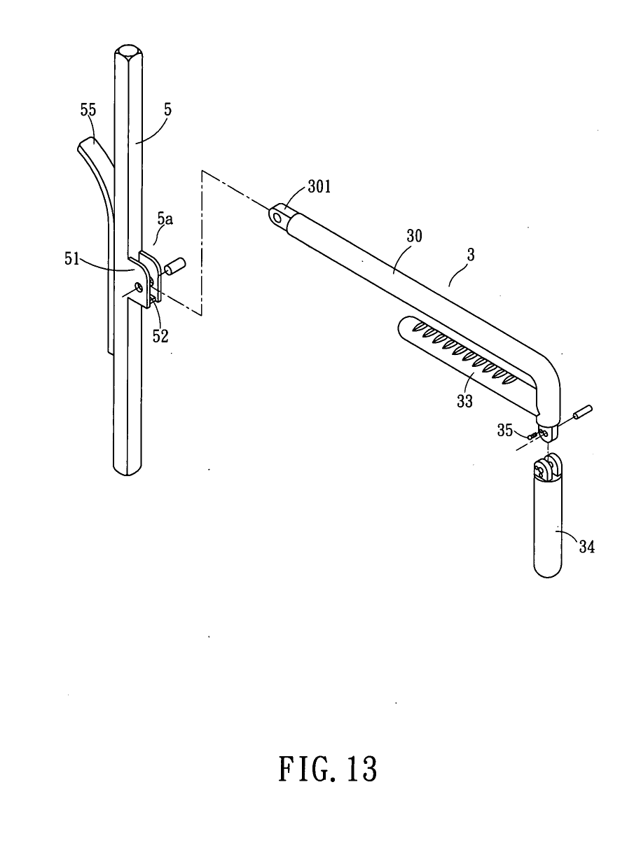

As shown in FIGS. 9˜12C, a fastener (5a) is disposed at a junction between the yoke tube (3) and the holding console (5). The fastener (5a) is composed of a pair of flaps (51) projected toward the yoke tube at a middle of the holding console (5), a spring (54) fits over a bolt (53). A distal closed end of the frame (51) is shaped as a shield (52). The yoke tube (3) includes a branched pole (30) has a cast hinge (301) at a first end connected to the flaps (51); the branched pole (30) is mainly parallel to a stub axle (33), but a second end of the branched pole (30) is bent downward and connected to a second end of the stub axle (33); a elastic positioning member (35) consists of a ball urged by a spring loaded within a tube, and a handle (34). When the bolt (53) is horizontally screwed to the cast hinge (301), the holding console (5) can be rotated in counterclockwise direction at a selected angle, by which the bolt (53) resists against the holding console (5) in the flaps (51) and stops rotating the holding console (5). (as shown in FIG. 13) That is, a depth of the bolt (53) screwed to the cast hinge (301) can be adjusted to determine a rotated angle (i.e. an inclined angle) of the holding console (5) to suit occasions for shielding various audio systems of vehicles. Therefore, the holding console (5) hardly shields the audio system with a space left in between for an unauthorized person to operate or remove the audio system. Furthermore, a shield (55) disposed between the holding console (5) and the audio system is screwed to a dashboard. The shield (55) has a plurality of screw holes vertically formed thereon. By which the shield (55) can be adjusted upward and downward to shield the audio system.

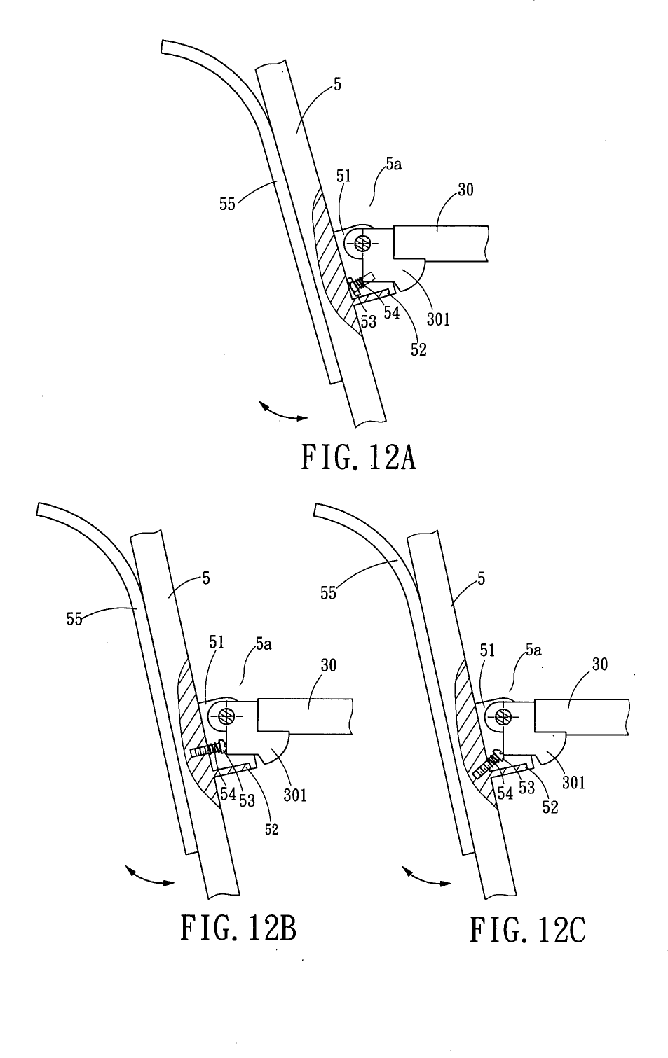

In addition, the bolt (53) can be screwed to the cast hinge (301) of the branched pole (30) at an angle (as shown in FIG. 12A), or the bolt (53) is screwed to an inner surface of the holding console (5) horizontally (as shown in FIG. 12 B) or at an angle (as shown in FIG. 12C). An oblique placement or horizontal placement (i.e. at an angle or horizontally) of the bolt (53) resists against the holding console (5) may adjust an inclined degree of the holding console (5).

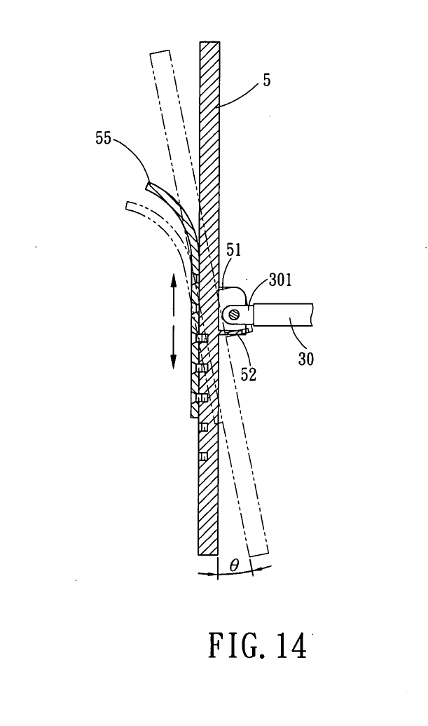

As shown in FIGS. 13-14, the yoke tube (3) is in the shape of “F”, it includes a branched pole (30) is mainly parallel to a stub axle (33), a first end of the branched pole has a cast hinge (301) connected to the flaps (51) of the holding console (5), a second end of the branched pole (30) bent downward is connected to a second end of the stub axle (33), where a detachable handle (34) is incorporated to the yoke tube (3) by an elastic positioning member (35). As shown in FIG. 14, a stopper (52) resists against the cast hinge (301) can also exert a force to limit an angle of rotation of the holding console (5) in counterclockwise direction.

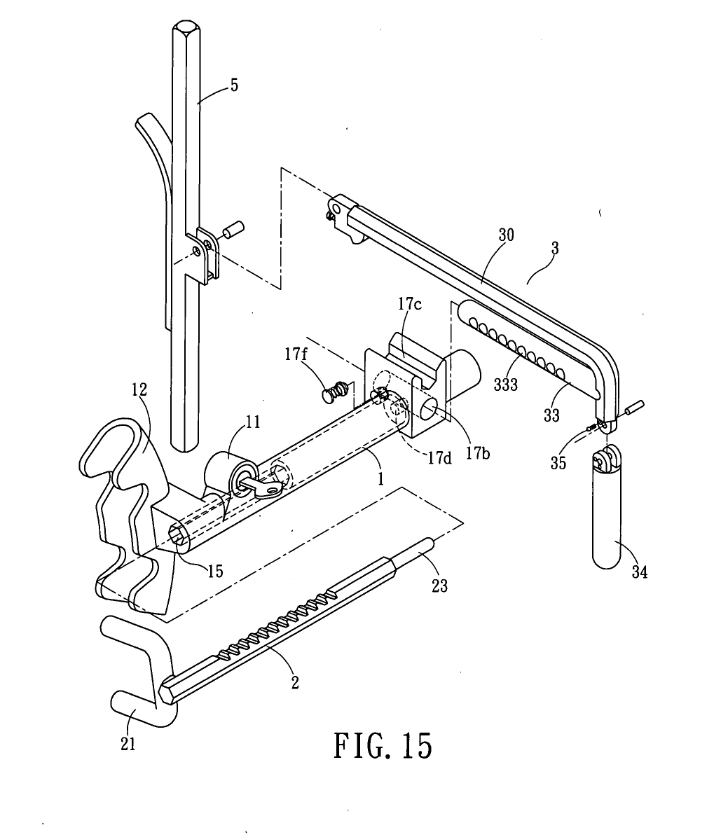

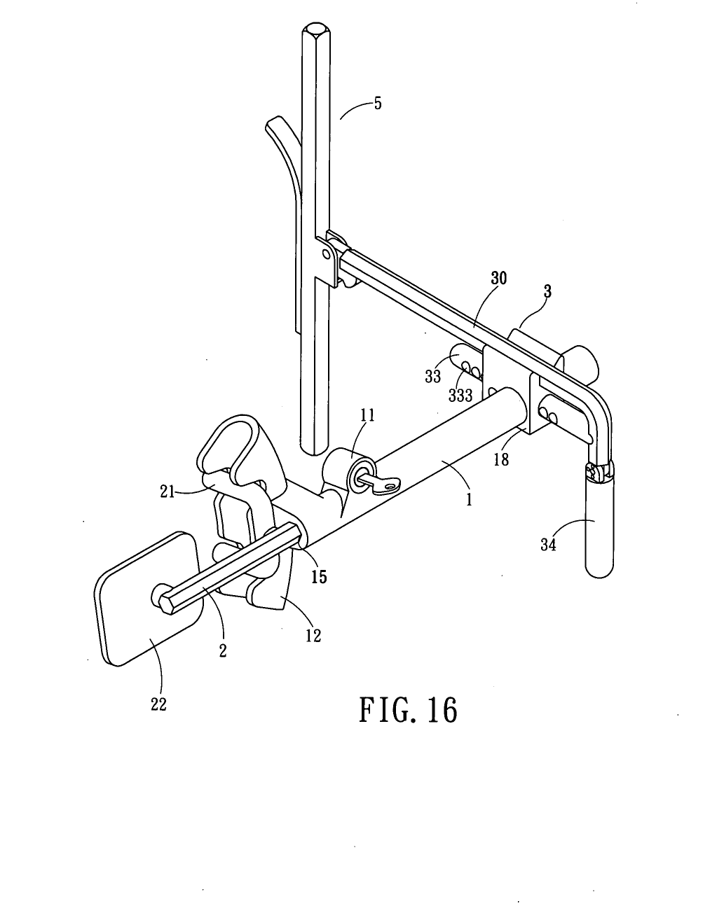

As shown in FIGS. 15-16, a steering wheel lock of a second type of the first embodiment of the invention is different from the first type by the yoke tube (3), buckles (12, 21), and stub end (18). The yoke tube (3) includes a branched pole (30) is mainly parallel to a stub axle (33) with a bent second end connected to a second end of the stub axle (33) further connected to a handle by an elastic positioning member (35). The stub axle (33) has a plurality of positioning holes (333), which one of the positioning holes (333) accommodates a positioning bolt (23) of the kingpin axle (2) stopped sliding is determined by operating the lock head (11). An axial hole (17b) formed through the stub end (18) accommodates the stub axle (33) sliding therein; a guiding groove (17c) parallel to the axial hole (17b) accommodates the stub axle (33) sliding therein; and a guiding hole (17d) is formed through the axial hole (17b) and the axial hole (15) of the stub axle tube (1). As a result, when the steering wheel lock clamps three-spoke steering wheel by buckles (12, 21), the positioning bolt (23) of the kingpin axle (2) can pass through the guiding hole (17d) to the axial hole (17b) to stop sliding by one of the positioning holes (333). By which the yoke tube (3) can shield the audio system by a holding console (5) to clamp three-spoke steering wheel and shield audio system. Conversely, once the kingpin axle (2) is led out and detached from the stub axle tube (1), the yoke tube (3) is released from the locked steering wheel. The positioning holes (333) of the stub axle (33) further accommodates an elastic positioning member (17f) fit in, the elastic positioning member (17f) is transversally disposed to the axial hole (17b). The elastic positioning member (17f) consists of a ball urged by a spring, when the spring is extended, the ball corresponding to the positioning hole (333) can fit in the positioning hole (333). Since the elastic positioning member (17f) keeps a distance to the positioning bolt (23), the distance is equal to a space between two adjacent positioning holes (333). Once the stub axle (33) slides from one positioning holes (333) to adjacent ones, both two adjacent positioning holes (333) during the movement is vertically in alignment with the elastic positioning member (17f) and the positioning bolt (23) in the guiding hole (17d), and these two adjacent positioning holes can be filled by both the positioning bolt (23) and the elastic positioning member (17f). Otherwise, the positioning bolt (23) could not fit in the positioning holes (333).

Next, as shown in FIG. 16, a buckle (12) at a first end of the stub axle tube (1) is a U-shaped disk; a buckle (21) at a first end of the kingpin axle (2) is a U-shaped lock fork. And a cap (22) can be added near the first end of the kingpin axle (2) to shield an airbag equipped at a center of the steering wheel.

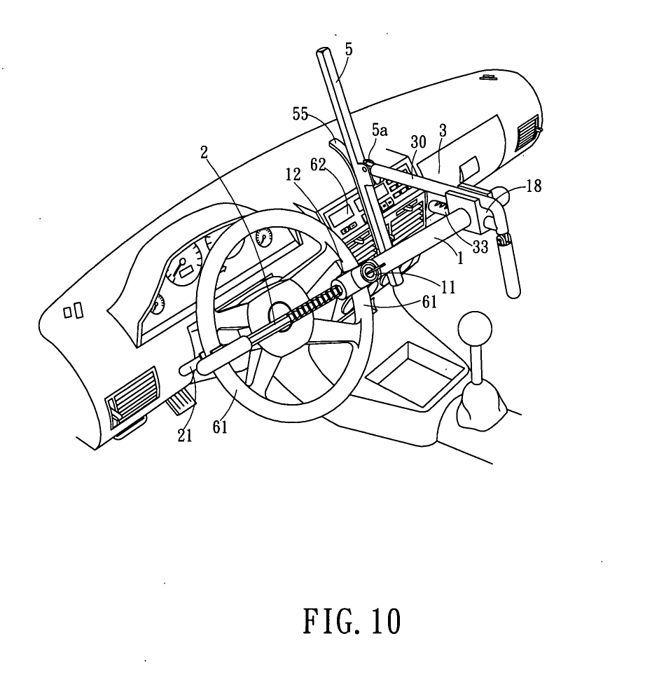

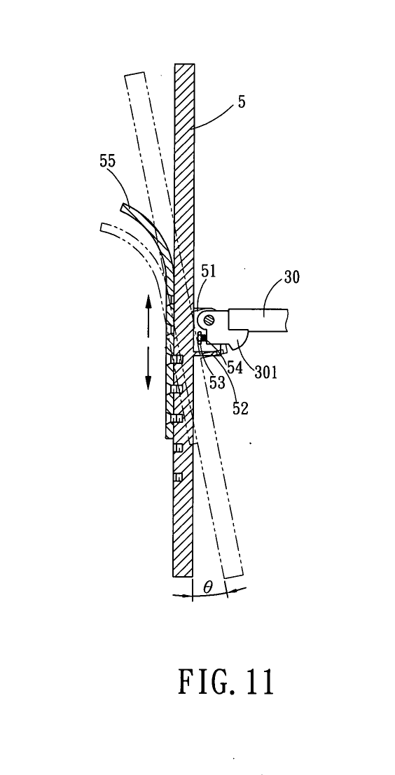

Because the buckles (12, 21) of the first type of the first embodiment of the invention are opposite to each other to clamp the three-spoke steering wheel from inner sides of the same (as shown in FIG. 10), while the buckles (12, 21) of the second type of the first embodiment of the invention clamp the three-spoke steering wheel from outer sides of the same (not shown). However, the buckles (12, 21) of the first and second types of the first embodiment of the invention clamp the steering wheel or release the same from locked status can be operated in different orientations.

### Second Embodiment

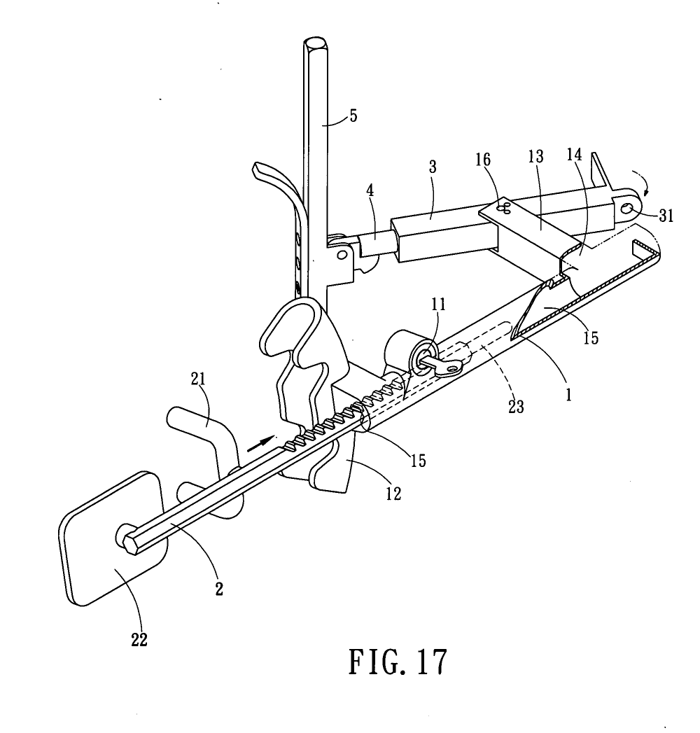

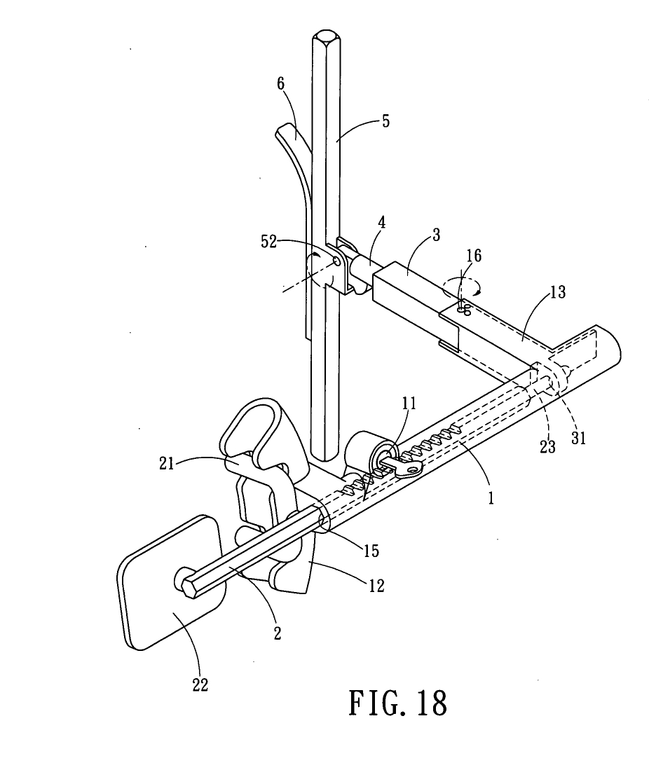

As shown in FIGS. 17˜18, a steering wheel lock includes a stub axle tube (1) has an axial hole (15) at a first end, and a lock head (11) as well as a buckle (12) attached near the first end. A guiding pole (13) is connected to the stub axle tube (1) at a right angle; a kingpin axle (2) sliding in the axial hole (15) of the stub axle tube (1) sets a limit to a range of movement of a yoke tube (3) by operating the lock head (11) as described in the first embodiment; the kingpin axle (2) has a buckle (21) at a first end. A yoke tube (3) passes through a lower portion of the guiding pole (13) to an inner side of the stub axle tube (1); furthermore, the yoke tube (3) is in a locked status or released from the locked status is determined by the kingpin axle (2); a second end of the yoke tube (3) is connected to a holding console (5).

As mentioned above, an axial hole (15) of the stub axle tube (1) is formed through the whole tube. A buckle (12) of the stub axle tube (1) is a U-shaped disk oriented in the same direction same as the stub axle tube (1). A buckle (21) of the kingpin axle (2) is a U-shaped fork lock vertically connected to the kingpin axle (2). Next, an airbag can be mounted to a center of the steering wheel, a cap (22) added to the first end of the kingpin axle (2) can shield the air bag.

As mentioned above, at least, a positioning hole (31) is provided to a first end of the yoke tube (3), after the positioning hole (31) is vertically in alignment with and adapted to the axial hole (15) of the stub axle tube (1), a positioning bolt (23) axially extended from a second end of the kingpin axle (2) can insert in the positioning hole (31), or the positioning bolt (23) can be led out from the positioning hole (31). The yoke tube (3) can be fixed by the kingpin axle (2), or detached from the kingpin axle (2).

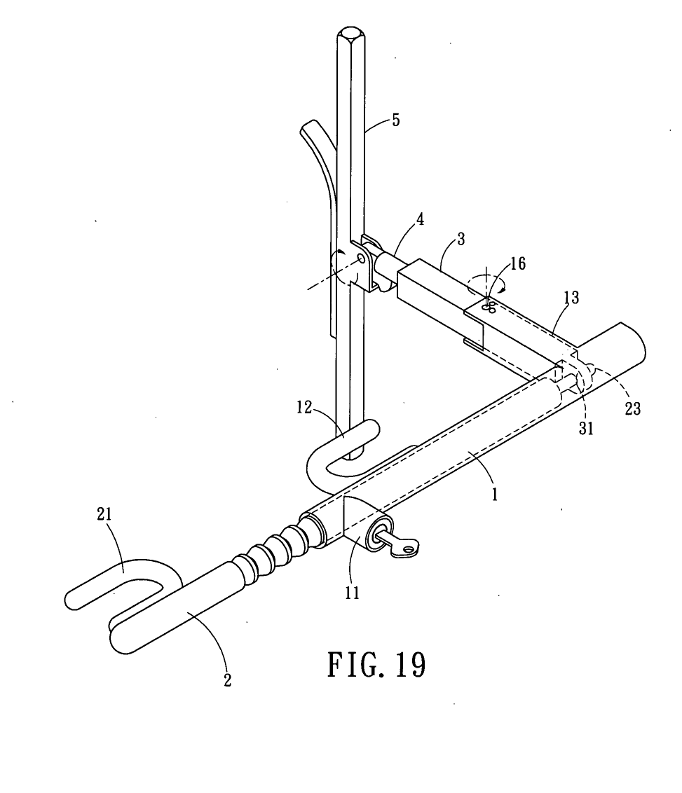

As mentioned above, whether the yoke tube (3) connected to the stub axle tube (1) vertically or not can be determined by rotating the kingpin axle (2). For example, once the kingpin axle is rotated in clockwise direction by an axial bolt (16); the positioning hole (31) approaches to the second end of the stub axle tube (1). A first end of the guiding pole (13) is pivotally connected to the yoke tube (3) by the axial bolt (16). An open trough (14) formed along a second end of the guiding pole (13) and the second end of the stub axle tube (1) accommodates the yoke tube (3) led in by rotating the kingpin axle (2) in clockwise direction to the yoke tube (3). The positioning hole (31) is formed at the second end of the yoke tube (3). When the yoke tube (3) led in the open trough (14) by rotating the kingpin axle (2) in clockwise direction, the positioning hole (31) is corresponding to and adapted to the axial hole (15) of the stub axle tube (1). Under such circumstance, as the kingpin axle (2) is moved transversally toward the yoke tube (3), the positioning bolt (23) extended from the second end of the kingpin axle (2) is inserted into the positioning hole (31); while the lock head (11) is turned to a lock status, the kingpin axle (2) is fixed by the lock head (11) without any movements, and the yoke tube (3) is also locked by the kingpin axle (2) without any movements. (as shown in FIG. 19) Thereby, the three-spoke steering wheel can be clamped and the audio system is shielded.

Conversely, when the lock head (11) is turned to release from a locked status, the kingpin axle (2) slides in reverse direction away from the yoke tube (3), the positioning bolt (23) at the second end of the kingpin axle (2) is detached from the positioning hole (31); therefore, the yoke tube (3) can be detached from the guiding pole (13) by the positioning bolt (23) as a center of rotation. That is, the steering wheel lock can be released from a locked status.

Next, a merit of the first type of the second embodiment of the invention is the yoke tube (3) is never detached from the stub axle tube (1), which is easy to operate. The yoke tube (3) can further be bent toward the stub axle tube (1); until it is parallel to the stub axle tube (1), a space occupied by the steering wheel lock is therefore reduced.

As shown in FIG. 19, a second type of the second embodiment of the invention is illustrated. The stub axle tube (1) has a buckle (12) shaped like an inverted barb, the kingpin axle (2) has a buckle (21) shaped like an inverted barb. Both buckles (12, 21) are formed as U-shaped fork locks facing outward to clamp the three-spoke steering wheel from inner side thereof.

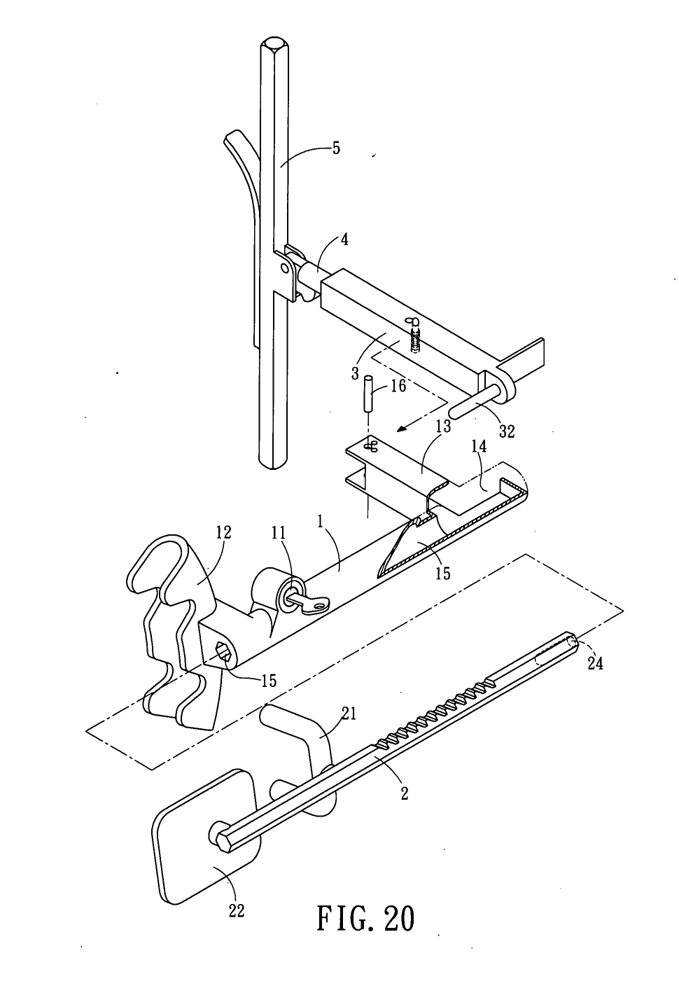

As shown in FIG. 20, a third type of the second embodiment of the invention is similar to the first type of the second embodiment. But, it is different from the first type by a second end of the yoke tube (3) as a positioning bolt (32) is in perpendicular connected to the yoke tube (3). A positioning hole (24) at a second end of the kingpin axle (2) is corresponding to and adapted to the positioning bolt (32). When the yoke tube (3) is led in the guiding pole (13) by rotating the yoke tube (3) in clockwise, the kingpin axle (2) can move transversally toward the yoke tube (3). As the positioning hole (24) accommodates the positioning bolt (24) inserted therein, the yoke tube (3) is fixed without movements. Conversely, when the positioning hole (24) is detached from the positioning bolt (32), the yoke tube (3) can be moved.

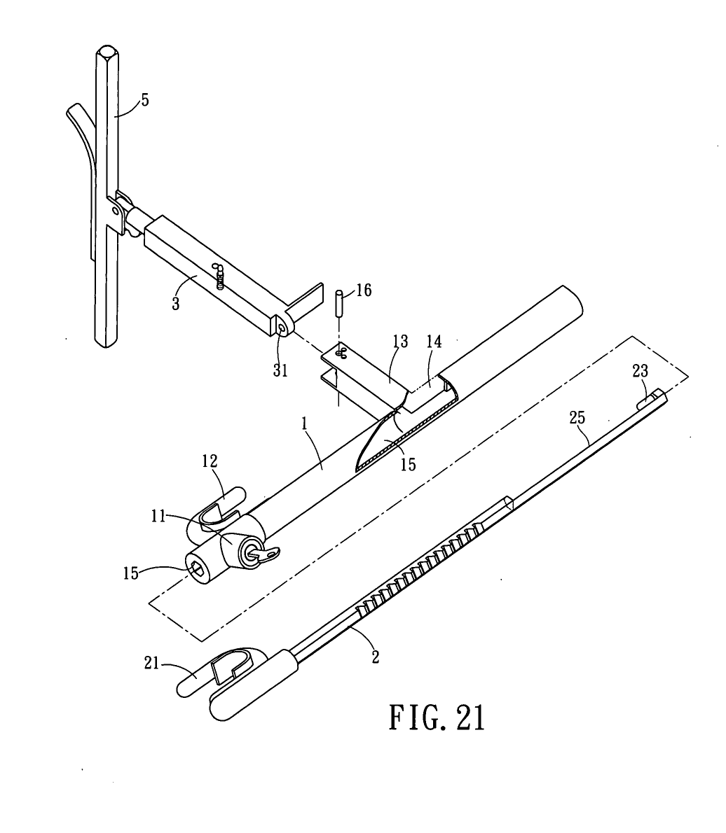

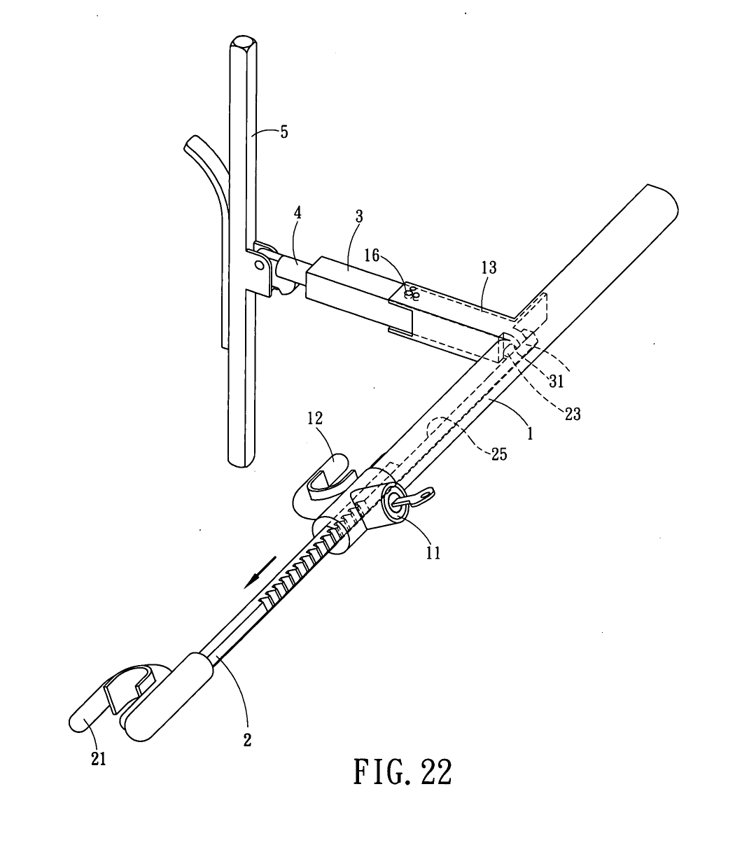

As shown in FIGS. 21˜22, the fourth type of the second embodiment of the invention are illustrated. The fourth type is different from the first type by a length of a second end of the kingpin axle (2) is stretched over a location of the guiding pole (13). A groove (25) is formed along the second end of the kingpin axle (2), a positioning bolt (23) parallel to the kingpin axle (2) is welded to the second end of the kingpin axle (2); when the positioning hole (31) is led in the groove (25), by transversally moving the kingpin axle (2), the positioning bolt (23) is able to insert into the positioning hole (31) to fix the yoke tube (3). (as shown in FIG. 22)

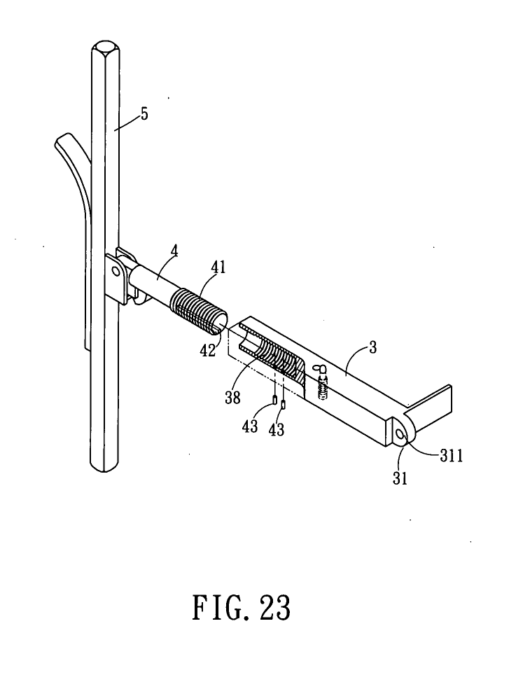

As shown in FIG. 23, an axle (4) installed between the yoke tube (3) and the holding console (5) adjusts a gap between the holding console (5) and the audio system. The axle (4) is screwed to inner threads on a screw hole (38) of the yoke tube (3) by outer threads (41), where a concave groove (42) is formed along the outer threads. The concave groove (42) allows bolts (43) passed through a bottom of the yoke tube (3) to the concaved groove (42). The axle (4) is therefore fixed to the yoke tube (3), until the holding console (5) is vertically connected to the stub axle tube (1). Therefore, users can adjust a length of the axle (4) exposed outside the yoke tube (3) according to a vertical distance of an audio system distant from the steering wheel. Rotation of the axle (4) or the yoke tube (3) is also prevented from happening in between due to the bolts (43) fix the axle (4) to the yoke tube (3).

### ADVANTAGES OF EMBODIMENTS OF THE INVENTION

By embodiments of the invention, advantages and benefits can be achieved as following:

1. Steering wheel can be clamped by buckles (12, 21) of the stub axle tube (1) and the kingpin axle (2); meanwhile, the holding console (5) at a second end of the yoke tube (3) shields audio system due to the yoke tube (3) slides in one direction only till a selected notch is mated with a fastener (19). Conversely, when the steering wheel is released from a “locked” status, not only the fastening status is freed, but also the holding console (5) is separated from the stub axle tube (1).

2. The yoke tube (3) is shaped in “F” shape, when the stub axle (33) is inserted in the stub end (18) results in the yoke tube (3) can be translated without any movements.

3. Handle (34) of the yoke tube (3) can be folded in toward the stub end (18) in position; the handle (34) also can be separated from the stub axle tube (1) to reduce occupied space.

4. The holding console (5) can be rotated to an extent to adapt to slope angles of different audio systems; otherwise, a space left between the audio system and the holding console (5) may induce unauthorized person operate or remove the audio system. It is said by the cited TW 133168 that some audio system has a volume restricted to only a width 13 cm, a length 25 cm, and a depth 20 cm.

5. After a “positioning bolt” (23) at a second end of the kingpin axle (2) is led in a lower portion of the guiding pole (13), the positioning bolt (23) is corresponding to and adapted to the axial hole (15) of the stub axle tube (1). Thereby, the positioning bolt (23) can be inserted in or detached from the stub axle tube (1). When inserted, both the yoke tube (3) and the kingpin axle (2) are secured to each other without movements, due to the latter is especially fixed by the lock head (11). Conversely, when the lock head (11) is unlocked, the kingpin axle (2) can be moved freely. But in the cited TW 133168, two lock heads are required to fix the kingpin axle (2) and the yoke tube (3) respectively, with two direction operations, which can be avoided from happening to the invention.

6. The guiding pole (13) is vertically connected to the yoke tube (3), which is therefore can be rotatable leading into the guiding pole (13) by way of the open trough (14). Whereby the yoke tube (3) is never detached from the stub axle tube (1); furthermore, the yoke tube (3) can be folded over, till it is parallel to the stub axle tube (1) to reduce occupied space.

What is claim claimed:

1. A multi-function steering wheel lock comprising:
a stub axle tube (1) has an axial hole (15), a lock head (11) and a buckle (12) at a first end, a stub end (18) at a second end;
a kingpin axle (2) slides in the axial hole (15) of the stub axle tube (1) also has a buckle (21) at a first end, thereby the lock head (11) sets a limit to a range of movement of the kingpin axle (2);
wherein a two pole convergence yoke tube (3), on one hand, inserts into the stub end (18), on the other hand, vertically connected to the stub axle tube (1) is in coordination with the kingpin axle (2), which is restricted to the fastening status—to be locked or not—is determined by a yoke tube (3) making a sliding movement perpendicular to the stub axle tube (1); in addition, a holding console (5) is pivotally connected to a first end of the yoke tube (3).

2. A multi-function steering wheel lock as claim 1 claimed wherein the stub end (18) has a fastener (19) can set a limit to of a range of movement of the yoke tube (3), by impelling a positioning bolt (26) extended from a second end of the kingpin axle (2) to the fastener (19) can release the yoke tube from a locked status.

3. A multi-function steering wheel lock as claim 2 claimed wherein the two pole convergence yoke tube (3) consists of a branched pole (30), a stub axle (33) is parallel to the branched pole (30); the stub axle (33) has a plurality of toothed notches (331), which is formed with one sided beveled notch (332) to adapt to the fastener (19) operated only in single direction.

4. A multi-function steering wheel lock as claim 2 claimed wherein inside the stub end (18), it includes a passage portion (17a) accommodates the fastener (19) pivotally mounted therein; an axial hole (17b) formed through the passage portion (17a) accommodates the stub axle (33) sliding therein; a guiding groove (17c) parallel to the axial hole (17b) accommodates the branched pole (30) sliding therein; and a guiding hole (17d) formed through the passage portion (17a) and the axial hole (15).

5. A multi-function steering wheel lock as claim 4 claimed wherein the fastener (19) is L-shaped, a first end of the fastener (19) has a slope surface (191) urged by a spring (192), which is pivotally mounted inside the passage portion (17a) secured by a bolt (193), the positioning bolt (26) shaped as a tongue-like tip impels the slope surface (191), which is therefore leverage upward a second end of the L-shaped fastener (19) tapers to a thin edge to release from mating with the one-sided beveled notches to facilitate a next mating between the stub axle (33) and the fastener (19).

6. A multi-function steering wheel lock as claim 3 claimed wherein inside the stub end (18), it includes an axial hole (17b) accommodates the embedded stub axle (33) sliding therein; a guiding groove (17c) parallel to the axial hole (17b) accommodates the branched pole (30) sliding therein; a passage portion (17e) is perpendicularly in communication with the passage portion (17b) for receiving the fastener (19) mounted therein; and a guiding hole (17d) formed through the passage portion (17a) as well as the axial hole (15).

7. A multi-function steering wheel lock as claim 6 claimed wherein the fastener (19) is shaped as a tube, which has a spring (192′) loaded within a bore (194), the spring (192′) is pivotally mounted inside the passage portion (17e) and fixed by a bolt (193) transversely inserted through the passage portion (17e); the bore (194) has an opening (196) with a slope surface (195); where the positioning bolt (26) extended from a second end of the kingpin (2) impels the slope surface (195) results in an elastic upward displacement of the fastener (19).

8. A multi-function steering wheel lock as claim 3 claimed wherein a handle (34) is an upright pole, which is vertically in combination with the branched pole (30), and the stub axle (33) in the shape of “F”.

9. A multi-function steering wheel lock as claim 8 claimed wherein the handle (34) is coupled with the branched pole (30), and the stub axle (33) by an elastic positioning member (35) inserted through an 8-shaped pivotal hole connected between the handle (34) and the yoke tube (3), thereby, when the handle (34) is folded in, the elastic positioning member (35) can be moved from left to right along the 8-shaped pivotal hole.

10. A multi-function steering wheel lock as claim 1 claimed wherein the holding console (5) is pivotally connected to the yoke tube (3) by a fastener (5a) to restrict a rotated angle of the holding console (5); the fastener (5a) consists of a pair of flaps (51) projected out toward the yoke tube (3) at a middle of the holding console (5); a distal end of the flaps (51) is closed shaped as a shield (52).

11. A multi-function steering wheel lock as claim 10 claimed wherein the yoke tube (3) consists of the branched pole (30) has a cast hinge (301) at a first end connected to the flaps (51), the branched pole (30) is mainly parallel to the stub axle (33) with a second end bent connected to a second end of the stub axle (33); further connected to the handle (34) by an elastic positioning member (35).

12. A multi-function steering wheel lock as claim 11 claimed wherein a spring fits over a bolt (53) loaded within and screwed to an inner side of the flaps (51) horizontally.

13. A multi-function steering wheel lock as claim 10 claimed wherein the yoke tube (3) includes a branched pole (30) is mainly parallel to a stub axle (33) and connected to the stub axle (33) by a bent second end, further connected to a handle (34) in the shape of “F”; a first end of the branched pole (30) has the cast hinge (301) connected to the pair of flaps (51) of the holding console (5).

14. A multi-function steering wheel lock as claim 1 claimed wherein the yoke tube (3) includes a branched pole (30) is mainly parallel to a stub axle (33) and connected to the stub axle (33) by a bent second end, further connected to a handle (34) by an elastic positioning member (35); the stub axle (33) has a plurality of positioning holes (31) adapted to a positioning bolt (23) fit in one of them, inside a stub end (18), it includes an axial hole (17b) accommodates the stub axle (33) sliding therein; a guiding groove (17c) parallel to the axial hole (17b) accommodates the branched pole (30) sliding therein; and a guiding hole (17d) formed through the axial hole (17b) as well as the axial hole (15) of the stub axle tube (1); an elastic positioning member (17f) mounted inside the axial hole (17b) can fit in one of the positioning holes (331).

15. A multi-function steering wheel lock comprising:
a stub axle tube (1) has a lock head (11), a buckle (12), and an axial hole (15) at a first end; and
a kingpin axle (2) slides in an axial hole (15) of the stub axle tube (1) has a buckle (21) at a first end, where the lock head (11) sets a limit to a range of movement of the kingpin axle (2);
wherein a guiding pole (13) near a second end of the stub axle tube (1) is vertically connected to the stub axle tube (1);
a yoke tube (3) is pivotally connected to the guiding pole (13), a first end of the yoke tube (3) led to a lower portion of the guiding pole (13); the kingpin axle (2) sets a limit to a range of movement of the yoke tube (3) or releases the yoke tube from a locked status; a second end of the yoke tube (3) has a holding console (5).

16. A multi-function steering wheel lock as claim 15 claimed wherein a lateral side of the guiding pole (13) and a first end of the stub axle tube (1) have an open trough (14) for leading the yoke tube (3) in the guiding pole (13) by rotating the kingpin axle (2) in clockwise direction.

17. A multi-function steering wheel lock as claim 15 claimed wherein an axle (4) between the yoke tube (3) and the holding console (5) adjusts a distance in between.

18. A multi-function steering wheel lock as claim 17 claimed wherein a second end of the yoke tube (3) has a positioning hole (31) led in a lower portion of the guiding pole (13) according to movements of the yoke tube (3), the positioning hole (31) is corresponding to and adapted to the axial hole (15) of the stub axle tube (1), thereby, the positioning bolt (23) extended from a second end of the kingpin axle (2) can be inserted in the stub axle tube (1) or detached therefrom.

19. A multi-function steering wheel lock as claim 17 claimed wherein a positioning bolt (32) extended from a second end of the yoke tube (3) is vertically connected to the yoke tube (3), the positioning bolt (3.2) led in a lower portion of the guiding pole (13) according to movements of the yoke tube (3), the positioning bolt (32) is therefore led in the axial hole (15) of the stub axle tube (1), where an axially positioning hole (24) at a second end of the kingpin axle (2) is inserted in the positioning hole (24) or detached therefrom.

20. A multi-function steering wheel lock as claim 17 claimed wherein a length of a second end of the kingpin axle (2) is stretched over a location of the guiding pole (13), a groove (25) is formed along the second end, a lateral side of the groove (25) has a positioning bolt (23) parallel to the kingpin axle (2); thereby, the positioning bolt (23) extended from a second end of the kingpin axle (2) can be inserted in the positioning hole (31) or detached therefrom.
